(19) United States
(12) Patent Application Publication
(10) Pub. No.: US 2026/0252154 A1
(43) Pub. Date: Aug. 27, 2026

(54) DATA PROCESSING DEVICE AND METHOD

(71) Applicant: Lenovo (Beijing) Limited, Beijing (CN)

(72) Inventor: Yi ZHANG, Beijing (CN)

(21) Appl. No.: 19/549,357

(22) Filed: Feb. 25, 2026

(30) Foreign Application Priority Data
Feb. 26, 2025 (CN) 202510217497.0

(51) Int. Cl. G06F 1/26; G06F 1/324

(52) U.S. Cl. CPC G06F 1/266; G06F 1/324

(57) ABSTRACT

A data processing device includes a processor configured to process data provided by an electronic device connected to the data processing device. The data processing device has a first mode and a second mode, and an operating frequency of the processor in the first mode is lower than an operating frequency of the processor in the second mode. In the first mode, the data processing device is powered by the electronic device. In the second mode, the data processing device is powered by a power supply module different from the electronic device. A power output by the power supply module to the data processing device is greater than a power output by the electronic device to the data processing device.

### CROSS-REFERENCE TO RELATED APPLICATION

This application claims priority to Chinese Patent Application No. 202510217497.0, filed on Feb. 26, 2025, the entire content of which is incorporated herein by reference.

### TECHNICAL FIELD

The present disclosure generally relates to the field of data processing technology and, more particularly, to a data processing device and method.

### BACKGROUND

In related art, a type of dedicated data processing device can connect to interfaces of other electronic devices (such as computers, tablets, etc.) to process data provided by other electronic devices using its own processor and return the processing results back to the other electronic devices.

The problem with this type of data processing device is that this type of data processing device needs other electronic devices to supply power during data processing. When the data processing device operates at a high frequency, the power consumption of the data processing device may exceed the power supply capacity of the other electronic devices, causing the data processing device to malfunction.

### SUMMARY

In accordance with the disclosure, there is provided a data processing device including a processor configured to process data provided by an electronic device connected to the data processing device. The data processing device has a first mode and a second mode, and an operating frequency of the processor in the first mode is lower than an operating frequency of the processor in the second mode. In the first mode, the data processing device is powered by the electronic device. In the second mode, the data processing device is powered by a power supply module different from the electronic device. A power output by the power supply module to the data processing device is greater than a power output by the electronic device to the data processing device.

Also in accordance with the disclosure, there is provided a data processing method including processing data provided by an electronic device connected to a data processing device on a processor of the data processing device in a first mode when the data processing device is powered by the electronic device, and processing the data provided by the electronic device on the processor of the data processing device in a second mode when the data processing device is powered by a power supply module different from the electronic device. An operating frequency of the processor in the first mode is less than an operating frequency of the processor in the second mode, and a power output by the power supply module to the data processing device is greater than a power output by the electronic device to the data processing device.

### BRIEF DESCRIPTION OF THE DRAWINGS

In order to more clearly illustrate the technical solutions of the embodiments of the present disclosure, the drawings for the description of the embodiments will be briefly introduced below. Obviously, the drawings described below are only some embodiments of the present disclosure, and those skilled in the art can obtain other drawings based on these drawings without creative effort.

FIG. 1 is a schematic structural diagram of a data processing device consistent with the present disclosure.

FIG. 2 is a schematic structural diagram of another data processing device consistent with the present disclosure.

FIG. 3 schematically shows a connection relationship between a data processing device and an electronic device consistent with the present disclosure.

FIG. 4 schematically shows a connection relationship between another data processing device and an electronic device consistent with the present disclosure.

FIG. 5 is a flowchart of a data processing method consistent with the present disclosure.

### DETAILED DESCRIPTION OF THE EMBODIMENTS

The technical solutions in the embodiments of the present disclosure will be described below with reference to the accompanying drawings. Obviously, the described embodiments are only some embodiments of the present disclosure, not all embodiments. Based on the described embodiments, all other embodiments obtained by those skilled in the art without creative effort are within the scope of the present disclosure.

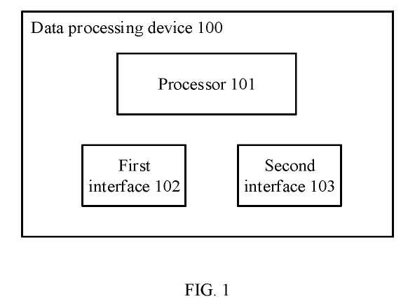

The present disclosure provides a data processing device. As shown in FIG. 1, the data processing device includes a processor 101, which can be used to process data provided by an electronic device. The electronic device is connected to the data processing device.

As shown in FIG. 1, the data processing device 100 includes a first interface 102 and a second interface 103. The first interface 102 can be connected to the electronic device, and the second interface 103 can be connected to a power supply module.

The data processing device includes a first mode and a second mode, and in the first mode, the operating frequency of processor 101 is lower than the operating frequency of processor 101 in the second mode.

In the first mode, the data processing device 100 is powered by an electronic device.

In the second mode, the data processing device 100 can be connected to a power supply module through the second interface 103, so that the data processing device 100 can be powered by a power supply module different from the electronic device. The power output from the power supply module to the data processing device 100 is greater than the power output from the electronic device to the data processing device 100.

The processor 101 may include one or more processors of any type. For example, processor 101 may include one or more graphics processing units (GPUs), one or more neural network processing units (NPUs), or a combination of a plurality of GPUs and NPUs.

Consistent with the present disclosure, the mode in which the data processing device 100 operates can be directly controlled by the processor 101. When the data processing device 100 is powered by an electronic device, the processor 101 actively switches to the first mode to operate. When the data processing device 100 is powered by a power supply module, the processor 101 actively switches to the second mode to operate.

In some embodiments, the operating frequency of processor 101 in the first mode is lower than the operating frequency of processor 101 in the second mode, which can mean that the upper limit of the operating frequency (or rated operating frequency) of processor 101 in the first mode is lower than the upper limit of the operating frequency of processor 101 in the second mode.

For example, the upper limit of the operating frequency of processor 101 in the first mode can be 700 megahertz (MHz), and the upper limit of the operating frequency of processor 101 in the second mode can be 1000 MHz.

In some embodiments, the real-time operating frequency of processor 101 in the first mode is lower than the real-time operating frequency of processor 101 in the second mode.

The first interface 102 can be any interface with data transmission and power transmission functions, such as a Thunderbolt interface, a Universal Serial Bus (USB) interface, etc. The second interface 103 can have both data transmission and power transmission functions, or only power transmission functions.

The electronic device that provides data to the data processing device 100 can be any type of multi-functional user terminal device, such as a laptop, desktop computer, tablet, or smartphone.

An electronic device usually includes several interfaces. A data processing device can connect to electronic devices through these interfaces. The electronic device supplies power to the data processing device through the interfaces and exchanges data with the data processing device through the interfaces.

For example, the interfaces of the electronic device include, but are not limited to, Thunderbolt interfaces and USB interfaces.

These Thunderbolt interfaces and USB interfaces have certain power supply limitations. For example, when the current value of the Thunderbolt interface exceeds a certain threshold (e.g., 3.3 amperes), the overcurrent protection (OCP) module of the electronic device will stop supplying power to the data processing device through that interface, which may lead to the data processing device stopping operation, loss of currently processed data, and other problems.

In the embodiments of the present disclosure, when the data processing device is powered by an electronic device with low output power, the data processing device operates in a first mode at a low operating frequency, which can provide a certain data processing capability while maintaining continuous and stable operation, avoiding abnormal situations such as device malfunction. On the other hand, when powered by a power supply module with higher output power, the data processing device operates in a second mode at a high operating frequency, thereby providing stronger data processing capabilities.

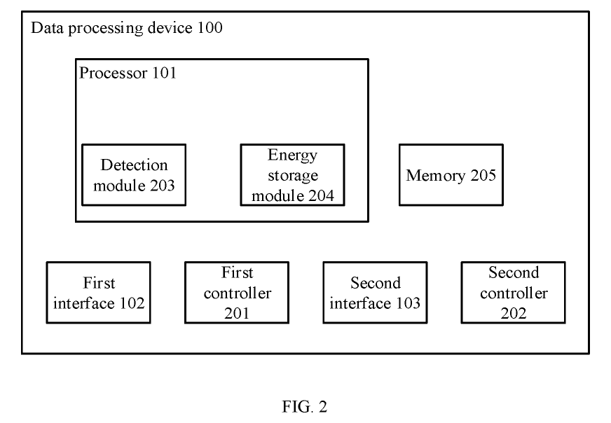

In some embodiments, as shown in FIG. 2, the data processing device further includes a first controller 201. The first controller 201 is configured to execute the following processes.

In the first mode, the first controller 201 is configured to send a first notification message to the electronic device, enabling the electronic device to supply power to the data processing device.

In the second mode, the first controller 201 is configured to send a second notification message to the electronic device, enabling the data processing device to receive power from the power supply module.

The first controller 201 can be a chip or control module that matches the interface protocol of the first interface 102. For example, if the first interface 102 is a Thunderbolt interface, the first controller 201 can be a corresponding Thunderbolt controller (TBT controller).

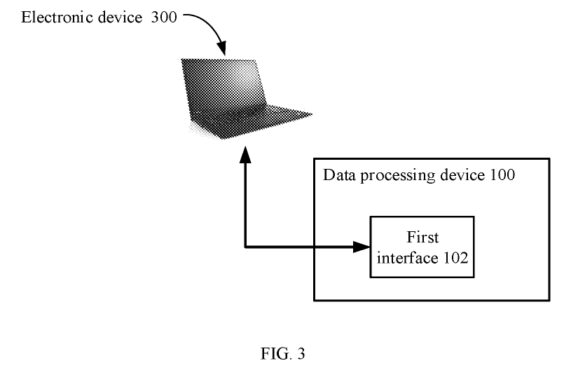

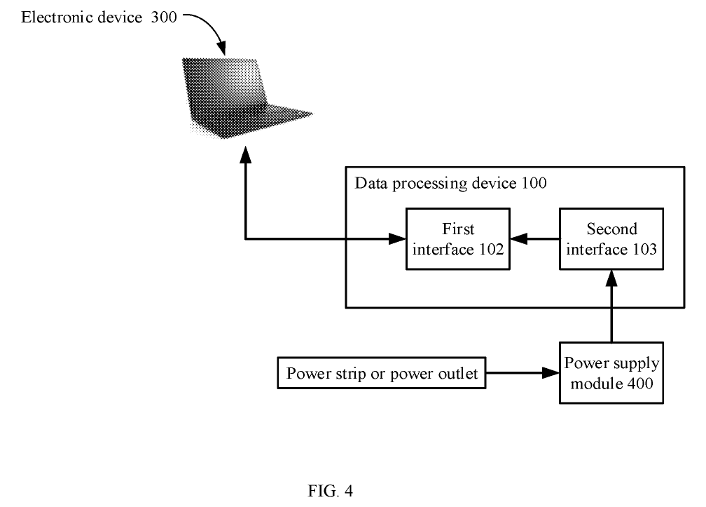

FIGS. 3 and 4 show the connection relationship between the data processing device 100, the electronic device 300, and the power supply module 400.

In the first mode, as shown in FIG. 3, the electronic device 300 is connected to the first interface 102 of the data processing device 100 via a connecting cable (e.g., a Thunderbolt cable). The data processing device 100 receives data from the electronic device 300 through the first interface 102, provides processing results to the electronic device 300 through the first interface 102, and receives power from the electronic device 300 through the first interface 102.

In the second mode, as shown in FIG. 4, the electronic device 300 is connected to the first interface 102 of the data processing device 100 via a connecting cable, and the power supply module 400 is connected to the second interface 103 of the data processing device 100 via a connecting cable, and the power supply module 400 is electrically connected to a power strip or power outlet.

In the connection relationship shown in FIG. 4, the power supply module 400 can draw power from the power grid through the power strip or power outlet, thereby supplying power to the data processing device 100 through the second interface 103. The data processing device 100 still receives data from the electronic device 300 and provides processing results to the electronic device 300 through the first interface 102.

In the connection relationship shown in FIG. 4, the data processing device 100 can also connect the first interface 102 and the second interface 103. Thus, if the electronic device 300 can receive power from the power supply module 400, the power supply module 400 can also supply power to the electronic device 300 through the second interface 103 and the first interface 102. When the electronic device 300 is a battery-powered portable terminal device, supplying power to the electronic device 300 from the power supply module 400 can reduce battery power consumption, allowing the electronic device 300 to operate for a longer time.

The first controller 201 can send the aforementioned notification messages to the electronic device 300 each time the data processing device 100 switches modes. That is, when the data processing device 100 switches from the second mode to the first mode, the first controller 201 sends a first notification message to the electronic device 300. When the data processing device 100 switches from the first mode to the second mode, the first controller 201 sends a second notification message to the electronic device 300.

The first controller 201 can send the aforementioned notification messages to the electronic device 300 when the power supply method of the data processing device changes. Specifically, if the first controller 201 detects that the power supply module 400 stops supplying power to the data processing device 100 while the power supply module 400 is continuously supplying power to the data processing device 100, the first controller 201 sends a first notification message to the electronic device 300. If the first controller 201 detects that the power supply module 400 is connected to the data processing device 100 while the electronic device 300 is continuously supplying power to the data processing device 100, the first controller 201 sends a second notification message to the electronic device 300.

The first controller 201 can detect the voltage of the second interface 103. If the detected voltage of the second interface 103 is greater than a certain value, it is determined that the power supply module 400 is connected to the data processing device 100. If the detected voltage of the second interface 103 is less than that value, it is determined that the power supply module 400 has stopped supplying power.

The first notification message and second notification message can be of various forms, which are not limited.

For example, the first controller 201 can configure a register within the controller that represents different modes. Different values of this register represent different modes, for example, a value of 0 of this register indicates that data processing device 100 is in the first mode, and a value of 1 of this register indicates that data processing device 100 is in the second mode.

When a switch from the second mode to the first mode is detected, or when the power supply module 400 is detected to have stopped supplying power, the first controller 201 will change the value of the register from 1 to 0 and send the changed value as a first notification message to the electronic device 300. When a switch from the first mode to the second mode is detected, or when the power supply module 400 is detected to start supplying power, the first controller 201 will change the value of the register from 0 to 1 and send the changed value as a second notification message to the electronic device 300.

The power supply module 400 can be any type of power adapter composed of electrical components such as transformers, rectifiers, and filters. The power supply module 400 can convert the AC power provided by the power grid (e.g., 220V three-phase AC power) into low-voltage pulsed DC power suitable for the data processing device 100.

In some embodiments, the data processing device 100 further includes the second controller 202 shown in FIG. 2. The second controller 202 can be used to control the processor to be in the first mode when the data processing device is not powered by the power supply module, and control the processor to be in the second mode when the data processing device is powered by the power supply module.

The second controller 202 can control the processor 101 to switch between different modes by controlling the upper limit of the operating frequency of the processor 101.

For example, the second controller 202 can set a 700 MHz operating frequency upper limit for the processor 101 when the power supply module 400 stops supplying power, so that the processor 101 operates in the first mode. The second controller 202 can also set a 1000 MHz operating frequency upper limit for the processor when the power supply module 400 starts supplying power, so that the processor 101 operates in the second mode.

As another example, the second controller 202 can remove the operating frequency limit of the processor 101 when the power supply module 400 starts supplying power, so that the processor 101 operates in the second mode, then the processor 101 can operate at the highest operating frequency allowed by the hardware of the processor 101. When the power supply module 400 stops supplying power, the second controller 202 sets an upper limit on the operating frequency of the processor 101 that is lower than the highest operating frequency allowed by the hardware, so that the processor 101 can operate in the first mode, and the processor 101 can operate at an operating frequency no higher than the set upper limit.

The second controller 202 can be any chip or control module capable of controlling the processor 101 to switch between different operating modes. For example, the second controller 202 can be a proportional plus derivative controller (PD controller).

In some embodiments, the data processing device may also include a detection module 203 as shown in FIG. 2. The detection module 203 is used to detect the power consumption parameter of the processor in the first mode.

When the data processing device 100 includes the detection module 203, the second controller 202 can also be used to control the operating frequency of the processor 101 in the first mode based on the power consumption parameter, to prevent the power consumption of the processor 101 from exceeding the power supply capacity of the electronic device 300.

The power consumption parameter can characterize the real-time power consumed by the processor 101. For example, the power consumption parameter can be a current parameter, characterizing the magnitude of the current currently being input to the processor 101 through the first interface 102, or the power consumption parameter can be a power parameter, characterizing the amount of power provided to the processor 101 by the first interface 102.

The detection module 203 can be a sensor capable of detecting specific power consumption parameter, such as a current sensor capable of detecting current, a power sensor capable of detecting power, etc.

The detection module 203 can be integrated into the processor 101 or be a separate module in the data processing device 100.

In some embodiments, the data processing device 100 may also include one or more light-emitting devices (e.g., LED lights) to indicate different states of the data processing device 100. For example, the light-emitting device can emit yellow light when the data processing device 100 is in the first mode, and green light when the data processing device 100 is in the second mode. As another example, the light-emitting device can emit red light when the power consumption parameter detected by the detection module 203 is greater than a certain threshold, and green light when the power consumption parameter detected by the detection module 203 is less than or equal to the threshold.

In some embodiments, the second controller 202 controls the operating frequency of the processor 101 in the following manner.

If the power consumption parameter is greater than or equal to a first power consumption parameter threshold, the operating frequency of the processor 101 is reduced by a first magnitude.

If the power consumption parameter is less than the first power consumption parameter threshold and greater than or equal to a second power consumption parameter threshold, the operating frequency of the processor 101 is maintained within current frequency range.

If the power consumption parameter is less than the second power consumption parameter threshold, the operating frequency of the processor 101 is increased by a second magnitude.

The first power consumption parameter threshold may be greater than or equal to the second power consumption parameter threshold.

The first magnitude may be equal to the second magnitude, or may be greater than the second magnitude. Setting the first magnitude greater than the second magnitude can prevent a large increase in operating frequency from causing the power consumption of the processor 101 to exceed the power supply capacity of the electronic device, further, reduce the operating frequency of the processor 101 faster when there is a risk of power consumption exceeding the power supply capacity. Therefore, setting the first magnitude greater than the second magnitude is more conducive to preventing problems that may arise when the power consumption of the processor 101 exceeds the power supply capacity.

The second controller 202 can control the operating frequency of the processor 101 by sending corresponding instructions to the processor 101.

For example, when the operating frequency of the processor 101 needs to be reduced by the first magnitude, an instruction to reduce the operating frequency by the first magnitude is sent to the processor 101. When the operating frequency needs to be maintained within the current frequency range, an instruction to continue operating in current state is sent to the processor 101, or no instruction is sent, allowing the processor 101 to operate in the current state by default. When the operating frequency of the processor 101 needs to be increased by the second magnitude, an instruction to increase the operating frequency by the second magnitude is sent to the processor 101.

The first power consumption parameter threshold and the second power consumption parameter threshold can be configured according to the power supply capacity of the electronic device 300. For example, the power consumption parameter can be a current parameter. When the electronic device 300 supplies power to the data processing device 100, a maximum current of 5 V, 3.3 A can provided. Correspondingly, the first power consumption parameter threshold can be set to 3.2 A, the second power consumption parameter threshold can be set to 3 A, the first amplitude can be 100 MHz, and the second amplitude can be 50 MHz.

Based on the above settings, when the data processing device 100 is in the first mode, if the detection module 203 detects that the current parameter exceeds 3.2 A, the second controller 202 sends an instruction to the processor 101 to reduce the frequency by 100 MHz, causing the processor 101 to reduce the operating frequency by 100 MHz from current level. If the detection module 203 detects that the current remains between 3 A and 3.2 A, the second controller 202 does not send any instructions to the processor 101, and the processor 101 operates within the current frequency range. If the detection module 203 detects that the current parameter is less than 3 A, the second controller 203 sends an instruction to the processor 101 to increase the frequency by 50 MHz, causing the processor 101 to increase the operating frequency by 50 MHz from the current level.

In some embodiments, the data processing device 100 may also include an energy storage module 204 as shown in FIG. 2. The energy storage module 204 can be used to supply power to the processor 101 during the switching process between the first mode and the second mode of the data processing device.

The energy storage module 204 can be a supercapacitor, a small rechargeable battery (e.g., a rechargeable button battery), or other devices capable of storing electrical energy.

The energy storage module 204 can supply power to the processor 101 in the following manner.

While the electronic device 300 is supplying power to the processor 101, the energy storage module 204 stops supplying power to the processor 101. At this time, if the amount of electricity stored in the energy storage module 204 is less than a certain threshold or less than the maximum capacity of the energy storage module 204, the second controller 202 can use the power provided by the electronic device 300 to charge the energy storage module 204 until the energy storage module 204 is fully charged.

While the electronic device 300 is supplying power to the processor 101, if the second controller 202 detects that the power supply module 400 is connected to the data processing device 100, the second controller 202 sends an instruction to the energy storage module 204 to start supplying power. The energy storage module 204 responds to the instruction and begins supplying power to the processor 101.

After the processor 101 completes circuit switching and begins receiving power from the power supply module 400, the second controller 202 sends an instruction to the energy storage module 204 to stop supplying power, and the energy storage module 204 stops supplying power. During the power supply by the power supply module 400, the second controller 202 can also use the power provided by the power supply module 400 to charge the energy storage module 204.

During the power supply by the power supply module 400, if the second controller 202 detects that the power supply module 400 has stopped supplying power, the second controller 202 sends an instruction to the energy storage module 204 to start supplying power. The energy storage module 204 responds to the instruction and begins supplying power to the processor 101.

After the processor 101 completes the circuit switching and begins receiving power from the electronic device 300, the second controller 202 sends an instruction to the energy storage module 204 to stop supplying power, and the energy storage module 204 stops supplying power.

Configuring the energy storage module 204 has the following benefits.

During the switching process between the power supply from the power supply module 400 and the electronic device 300, the processor 101 needs to first stop receiving power from one source and then receive power from the other source. During the time from when the processor 101 stops receiving power until the processor 101 receives power, neither the power supply module 400 nor the electronic device 300 can supply power to the processor 101. The energy storage module 204 can temporarily supply power to the processor 101 during the time from when the processor 101 stops receiving power until the processor 101 receives power, keeping the processor 101 powered on and preventing data loss due to power interruption during the switching process.

In some embodiments, the processor 101 is also configured to send a third notification message to the electronic device 300, the third notification message characterizing a frequency parameter of data processing device 100, receive a feedback message sent by the electronic device 300 in response to the third notification message, and process data provided by the electronic device 300 using the first model or the second model based on the feedback message, the power consumption of processing data using the first model being greater than the power consumption of processing data using the second model.

A number of model parameters in the first model may be greater than a number of model parameters in the second model. The first model and the second model can be of same type or different types. For example, both the first model and the second model can be large language models used for processing text. As another example, the first model is an image generation model used to generate images based on input information, and the second model is a large language model.

The third notification message may include at least one of the upper limit of the operating frequency of processor 101, the real-time operating frequency, or the mode of processor 101.

When the third notification message only includes the upper limit of the operating frequency, the electronic device 300 can compare the upper limit of the operating frequency with a frequency threshold. If the upper limit of the operating frequency is greater than the frequency threshold, the feedback message sent can instruct processor 101 to process the data using the first model. If the upper limit of the operating frequency is less than or equal to the frequency threshold, the feedback message sent can instruct processor 101 to process the data using the second model.

When the third notification message only includes the real-time operating frequency, the electronic device 300 can compare the real-time operating frequency with a frequency threshold. If the real-time operating frequency is greater than the frequency threshold, the feedback message sent can instruct processor 101 to process the data using the first model. If the real-time operating frequency is less than or equal to the frequency threshold, the feedback message sent can instruct processor 101 to process the data using the second model.

When the third notification message only includes the mode of processor 101, the electronic device 300 can determine whether processor 101 is in the first mode or the second mode. If the processor 101 is in the first mode, the feedback message sent can instruct the processor 101 to process the data using the second model. If the processor 101 is in the second mode, the feedback message sent can instruct the processor 101 to process the data using the first model.

When the sent third notification message includes at least the real-time operating frequency, a corresponding feedback message is sent based on a comparison result of the real-time operating frequency. When the sent third notification message only includes the upper limit of the operating frequency and the mode, a corresponding feedback message is sent based on a comparison result of the upper limit of the operating frequency.

In some embodiments, when processor 101 processes data using either the first model or the second model, the processor of electronic device 300 can process other data using the other model. For example, when processor 101 processes data using the first model, the processor of electronic device 300 can process data using the second model. The data processed by the processor 101 and the processor of electronic device 300 can be the same or different.

To enable electronic device 300 to receive the third notification message, a driver program adapted to data processing device 100 can be pre-installed in the operating system of electronic device 300. After the third notification message is received by the driver program, the driver program can report the third notification message to an application of electronic device 300, allowing the application to send a corresponding feedback message to the data processing device 100 in the manner described above.

The frequency threshold used for comparison can be a pre-set fixed value, or the frequency threshold can be determined based on the rated frequency of the processor of electronic device 300. For example, the frequency threshold can be equal to the rated frequency of the processor of electronic device 300, e.g., if the rated frequency of the processor of electronic device 300 is 700 MHz, the frequency threshold can be set to 700 MHz.

In some embodiments, data processing device 100 may also include memory 205 shown in FIG. 2, used to store the model parameters of the first model and the model parameters of the second model provided by the electronic device.

Memory 205 can be any type of memory, such as double data rate synchronous dynamic random access memory (DDR).

In addition to model parameters, memory 205 can also be used to store intermediate data generated during the processing by processor 101.

The model parameters of the first model and the model parameters of the second model can be pre-written by relevant manufacturers, or be written to memory 205 by electronic device 300 when data processing device 100 and electronic device 300 establish a connection.

When processor 101 processes the data provided by the electronic device using the first model or the second model based on the feedback message, the processor 101 can be used to, when the feedback message indicates processing data using the first model, load the model parameters of the first model from memory 205 to process the data according to the model parameters of the first model, and, when the feedback message indicates processing data using the second model, load the model parameters of the second model from memory 205 to process the data according to the model parameters of the second model.

Each time processor 101 loads model parameters from memory 205 for a particular model, processor 101 can discard the model parameters of another model that were previously loaded and delete the data processed by that another model stored in memory 205.

For example, when data processing device 100 is connected to electronic device 300, processor 101 first loads the model parameters of the first model, and the first model is used to process the data provided by the electronic device 300. After a period of time, the upper limit of the operating frequency of processor 101 changes, becoming less than the frequency threshold. Processor 101 then responds to the feedback message running the second model, discards the model parameters of the first model previously loaded into processor 101, deletes the intermediate data generated during the execution of the first model and the data needed as input for the first model stored in memory 205, and loads the model parameters of the second model from memory 205. If, after a period of time, the upper limit of the operating frequency becomes greater than the frequency threshold, processor 101 can respond to the feedback message running the first model, discard the model parameters of the second model previously loaded into processor 101, delete the intermediate data generated during the execution of the second model and the data needed as input for the second model stored in memory 205, and load the model parameters of the first model from memory 205, and so on.

When the data processing device 100 includes an energy storage module 204, then during the switching between the first mode and the second mode of the data processing device 100, the energy storage module 204 can also supply power to the memory 205.

In some embodiments, the data processing device 100 may also include a cooling module 206 as shown in FIG. 2. In the first mode, the cooling module 206 can be powered by the electronic device 300, and in the second mode, the cooling module 206 can be powered by the power supply module 400.

The cooling module 206 can be controlled by the processor 101, operating based on the real-time operating frequency of the processor 101, to promptly dissipate the heat generated by the processor 101 to the external environment, preventing the processor 101 from overheating.

The cooling module 206 can be an air-cooled heat sink (e.g., a fan), or other forms of heat sink. The fan speed can be controlled by the processor 101 based on the real-time operating frequency. A real-time fan speed is positively correlated with the real-time operating frequency of the processor 101.

When the data processing device 100 includes an energy storage module 204, then during the switching between the first mode and the second mode of the data processing device 100, the energy storage module 204 can also supply power to the cooling module 206.

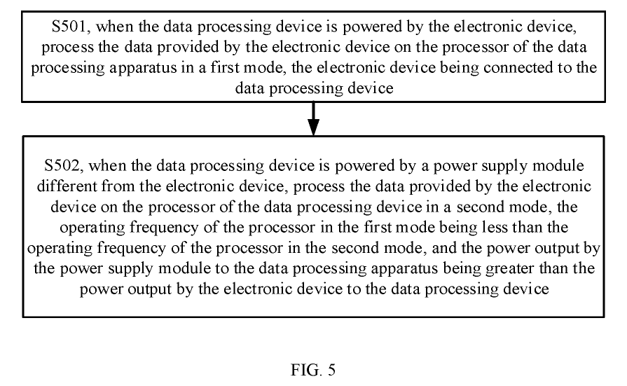

The present disclosure provides a data processing method, as shown in FIG. 5, the method includes the following.

At S501, when the data processing device is powered by the electronic device, the data provided by the electronic device is processed on the processor of the data processing device in a first mode, the electronic device being connected to the data processing device.

At S502, when the data processing device is powered by a power supply module different from the electronic device, the data provided by the electronic device is processed on the processor of the data processing device in a second mode, the operating frequency of the processor in the first mode being less than the operating frequency of the processor in the second mode, and the power output by the power supply module to the data processing device being greater than the power output by the electronic device to the data processing device.

In some embodiments, the method further includes the following.

A third notification message is sent to the electronic device, the third notification message characterizing the frequency parameter of the data processing device.

A feedback message sent by the electronic device is received in response to the third notification message.

The data provided by the electronic device is processed based on the feedback message using the first model or the second model, the power consumption of processing data using the first model being greater than the power consumption of processing data using the second model.

In some embodiments, processing the data provided by the electronic device based on the feedback message using the first model or the second model includes the following.

When the feedback message indicates processing data using the first model, loading the model parameters of the first model from the memory of the data processing device to process the data according to the model parameters of the first model.

When the feedback message indicates processing data using the second model, loading the model parameters of the second model from the memory to process the data according to the model parameters of the second model.

In some embodiments, the data processing method in the present disclosure further includes the following.

In the first mode, a first notification message is sent to the electronic device, enabling the electronic device to supply power to the data processing device.

In the second mode, a second notification message is sent to the electronic device, enabling the electronic device to receive power from the power supply module.

In some embodiments, the data processing method in the present disclosure further includes the following.

A power consumption parameter of the processor is detected;

An operating frequency of the processor is controlled according to the power consumption parameter.

In some embodiments, controlling the operating frequency of the processor according to the power consumption parameter includes, when the power consumption parameter is greater than or equal to the first power consumption parameter threshold, reducing the operating frequency of the processor by a first magnitude, when the power consumption parameter is less than the first power consumption parameter threshold and greater than or equal to the second power consumption parameter threshold, maintaining the operating frequency of the processor within the current frequency range, and when the power consumption parameter is less than the second power consumption parameter threshold, increasing the operating frequency of the processor by a second magnitude.

In some embodiments, the data processing method in the present disclosure further includes, during the process of the data processing device switching between the first mode and the second mode of the data processing device, controlling the energy storage module of the data processing device to supply power to the processor.

It should be noted that the various embodiments in this specification are described in a progressive manner, and each embodiment focuses on describing the differences from other embodiments. Similar parts between the embodiments can be cross-referenced.

For convenience of description, the above system or apparatus is divided into various modules or units based on their functions. Of course, when implementing the present disclosure, the functions of each unit can be implemented in one or more software and/or hardware.

From the description of the above embodiments, those skilled in the art can clearly understand that the present disclosure can be implemented by means of software plus the necessary general-purpose hardware platform. Based on this understanding, the technical solution of the present disclosure can be embodied in the form of a software product. This computer software product can be stored in a storage medium, such as ROM/RAM, magnetic disk, optical disc, etc., and includes a number of instructions to enable a computer device (which can be a personal computer, server, or network device, etc.) to execute the methods described in the various embodiments or parts of the embodiments of the present disclosure.

In the present disclosure, relational terms associated with “first,” “second,” “third,” and “fourth” are merely used to distinguish one entity or operation from another entity or operation, and do not need or imply any such actual relationship or order between these entities or operations. Furthermore, the terms associated with “comprise,” “include,” or any other variation thereof are intended to cover non-exclusive inclusion, so that a process, method, article, or device that includes a list of elements not only includes those elements, but also includes other elements not explicitly listed, or elements inherent to such a process, method, article, or device. Without further limitations, an element defined by the phrase “comprising a...” does not exclude the presence of other identical elements in the process, method, article, or device that includes the element.

The above description is only some embodiments of the present disclosure. It should be noted that those skilled in the art can make several modifications and refinements without departing from the spirit of the present disclosure, and these modifications and refinements should also be considered within the scope of the present disclosure.

What is claimed is:

1. A data processing device comprising:
a processor configured to process data provided by an electronic device connected to the data processing device;
wherein:
the data processing device has a first mode and a second mode, and an operating frequency of the processor in the first mode is lower than an operating frequency of the processor in the second mode;
in the first mode, the data processing device is powered by the electronic device; and
in the second mode, the data processing device is powered by a power supply module different from the electronic device, and a power output by the power supply module to the data processing device is greater than a power output by the electronic device to the data processing device.

2. The data processing device according to claim 1, further comprising:
a controller configured to:
in the first mode, send a first notification message to the electronic device to enable the electronic device to supply power to the data processing device; and
in the second mode, send a second notification message to the electronic device to enable the data processing device to receive power from the power supply module.

3. The data processing device according to claim 1, further comprising:
a controller, configured to:
control the processor to be in the first mode in response to the data processing device not being powered by the power supply module; and
control the processor to be in the second mode in response to the data processing device being powered by the power supply module.

4. The data processing device according to claim 3, further comprising:
a detection module, configured to detect a power consumption parameter of the processor in the first mode.

5. The data processing device according to claim 4, wherein the controller is further configured to control the operating frequency of the processor in the first mode according to the power consumption parameter.

6. The data processing device according to claim 5, wherein the controller is further configured to, when controlling the operating frequency of the processor according to the power consumption parameter:
in response to the power consumption parameter being greater than or equal to a first power consumption parameter threshold, decrease the operating frequency of the processor by a first magnitude;
in response to the power consumption parameter being less than the first power consumption parameter threshold and greater than or equal to a second power consumption parameter threshold, maintain the operating frequency of the processor within a current frequency range; and
in response to the power consumption parameter being less than the second power consumption parameter threshold, increase the operating frequency of the processor by a second magnitude.

7. The data processing device according to claim 1, further comprising:
an energy storage module, configured to supply power to the processor during the data processing device switching between the first mode and the second mode.

8. The data processing device according to claim 1, wherein the processor is further configured to:
send a notification message to the electronic device, the notification message representing a frequency parameter of the data processing device;
receive a feedback message sent by the electronic device in response to the notification message; and
process the data provided by the electronic device using a first model or a second model based on the feedback message, a power consumption of processing data using the first model being greater than a power consumption of processing data using the second model.

9. The data processing device according to claim 8, further comprising:
a memory, configured to store model parameters of the first model and model parameters of the second model provided by the electronic device.

10. The data processing device according to claim 9, wherein the processor is further configured to, when processing the data provided by the electronic device using the first model or the second model based on the feedback message:
load the model parameters of the first model from the memory in response to the feedback message indicating processing data using the first model, to process data according to the model parameters of the first model; or
load the model parameters of the second model from the memory in response to the feedback message indicating processing data using the second model, to process data according to the model parameters of the second model.

11. A data processing method comprising:
processing data provided by an electronic device connected to a data processing device on a processor of the data processing device in a first mode when the data processing device is powered by the electronic device; and
processing the data provided by the electronic device on the processor of the data processing device in a second mode when the data processing device is powered by a power supply module different from the electronic device;
wherein an operating frequency of the processor in the first mode is less than an operating frequency of the processor in the second mode, and a power output by the power supply module to the data processing device is greater than a power output by the electronic device to the data processing device.

12. The method according to claim 11, further comprising:
in the first mode, sending a first notification message to the electronic device, enabling the electronic device to supply power to the data processing device; and
in the second mode, sending a second notification message to the electronic device, enabling the electronic device to receive power from the power supply module.

13. The method according to claim 11, further comprising:
sending a notification message to the electronic device, the notification message representing a frequency parameter of the data processing device;
receiving a feedback message sent by the electronic device in response to the notification message; and
processing the data provided by the electronic device using a first model or a second model based on the feedback message, wherein a power consumption of processing data using the first model is greater than a power consumption of processing data using the second model.

14. The method according to claim 11, further comprising:
detecting a power consumption parameter of the processor; and
controlling the operating frequency of the processor according to the power consumption parameter.

15. The method according to claim 11, wherein controlling the operating frequency of the processor according to the power consumption parameter includes:
in response to the power consumption parameter being greater than or equal to a first power consumption parameter threshold, decrease the operating frequency of the processor by a first magnitude;
in response to the power consumption parameter being less than the first power consumption parameter threshold and greater than or equal to a second power consumption parameter threshold, maintain the operating frequency of the processor within a current frequency range; and
in response to the power consumption parameter being less than the second power consumption parameter threshold, increase the operating frequency of the processor by a second magnitude..

16. The method according to claim 11, further comprising:
during the data processing device switching between the first mode and the second mode, controlling an energy storage module of the data processing device to supply power to the processor.
